(19) United States
(12) Patent Application Publication
(10) Pub. No.: US 2021/0347236 A1
(43) Pub. Date: Nov. 11, 2021

(54) VEHICLE ROOF DEVICE

(71) Applicants: KABUSHIKI KAISHA TOYOTA JIDOSHOKKI, Kariya-shi, Aichi (JP); TOYOTA JIDOSHA KABUSHIKI KAISHA, Toyota-shi, Aichi (JP)

(72) Inventors: Yuichi MIZUTANI, Kariya-shi (JP); Masaaki TANAKA, Toyota-shi (JP)

(73) Assignees: KABUSHIKI KAISHA TOYOTA JIDOSHOKKI, Kariya-shi, Aichi (JP); TOYOTA JIDOSHA KABUSHIKI KAISHA, Toyota-shi, Aichi (JP)

(21) Appl. No.: 17/286,901

(22) PCT Filed: Oct. 15, 2019
(86) PCT No.: PCT/JP2019/040445

§ 371 Date: Apr. 20, 2021

(30) Foreign Application Priority Data
Oct. 23, 2018 (JP) 2018-198833

(51) Int. Cl. B60J 7/043

(52) U.S. Cl. CPC B60J 7/043

(57) ABSTRACT

A vehicle roof device includes a plastic roof panel that is configured to be fixed to a body of a vehicle and includes an inner peripheral edge forming a substantially rectangular opening, a roof window that is capable of closing the opening, and a frame member that is bonded to a back face of the plastic roof panel so as to extend along the inner peripheral edge. The frame member is fixed to the body.

### TECHNICAL FIELD

The present disclosure relates to a vehicle roof device that includes a plastic roof panel.

### BACKGROUND ART

For example, Patent Document 1 discloses a vehicle roof device that includes an upper member and a sunroof panel. The sunroof panel is arranged on the peripheral edge of an opening in a roof panel with the upper member in between. A weather strip, which serves as a seal, is provided between the sunroof panel and the upper member.

In recent years, vehicle roof devices having plastic roof panels have been developed for the purpose of weight reduction and production facilitation of vehicles. For example, a vehicle roof device shown in FIG. 9 includes a plastic roof panel 122, which is fixed to a body 121 of a vehicle, and an openable glass roof window 123, which is supported by the plastic roof panel 122. The plastic roof panel 122 includes weather strips 124, 125, which prevent entry of water or noise through the clearances between the roof window 123 and the plastic roof panel 122.

### PRIOR ART DOCUMENT

### Patent Document

Patent Document 1: Japanese Laid-Open Utility Model Publication No. 58-129220

### SUMMARY OF THE INVENTION

### Problems that the Invention is to Solve

However, the vehicle roof device shown in FIG. 9 has a drawback in that the plastic roof panel 122 is deformed due to thermal contraction. Deformation of the plastic roof panel 122 creates a gap between the plastic roof panel 122 and the weather strips 124, 125. This may allow water and noise to enter the passenger compartment.

It is an objective of the present disclosure to provide a vehicle roof device that is capable of increasing the stiffness of a plastic roof panel and reducing deformation of the plastic roof panel due to thermal contraction.

### Means for Solving the Problems

In one aspect of the present disclosure, a vehicle roof device includes a plastic roof panel that is configured to be fixed to a body of a vehicle and includes an inner peripheral edge forming a substantially rectangular opening, a roof window that is capable of closing the opening, and a frame member that is bonded to a back face of the plastic roof panel so as to extend along the inner peripheral edge. The frame member is fixed to the body.

### BRIEF DESCRIPTION OF THE DRAWINGS

FIG. 1 is an exploded perspective view schematically showing a vehicle roof device according to a first embodiment.

FIG. 2 is a plan view of the vehicle roof device shown in FIG. 1.

FIG. 3 is a cross-sectional view taken along line 3-3 of FIG. 2.

FIG. 4 is a cross-sectional view taken along line 4-4 of FIG. 2.

FIG. 5 is a perspective view partially showing a frame member.

FIG. 6 is a cross-sectional side view partially showing a vehicle roof device according to a second embodiment.

FIG. 7 is a cross-sectional front view showing the vehicle roof device shown in FIG. 6.

FIG. 8A is a perspective view partially showing a frame member according to a first modification.

FIG. 8B is a cross-sectional view partially showing a frame member according to a second modification.

FIG. 9 is a cross-sectional view partially showing a conventional vehicle roof device.

### MODES FOR CARRYING OUT THE INVENTION

### First Embodiment

A vehicle roof device according to a first embodiment will now be described with reference to the drawings. The vehicle in the present embodiment is an automobile. The terms front, rear, left, right, up, and down, which are used to identify directions, are defined with respect to a state in which the driver seated in the driver's seat faces in the forward moving direction of the vehicle.

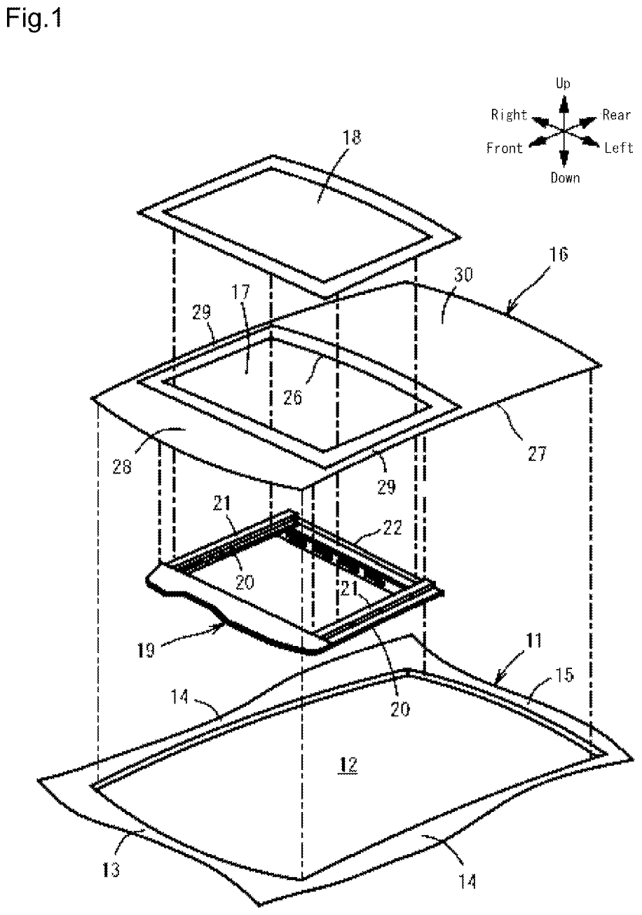

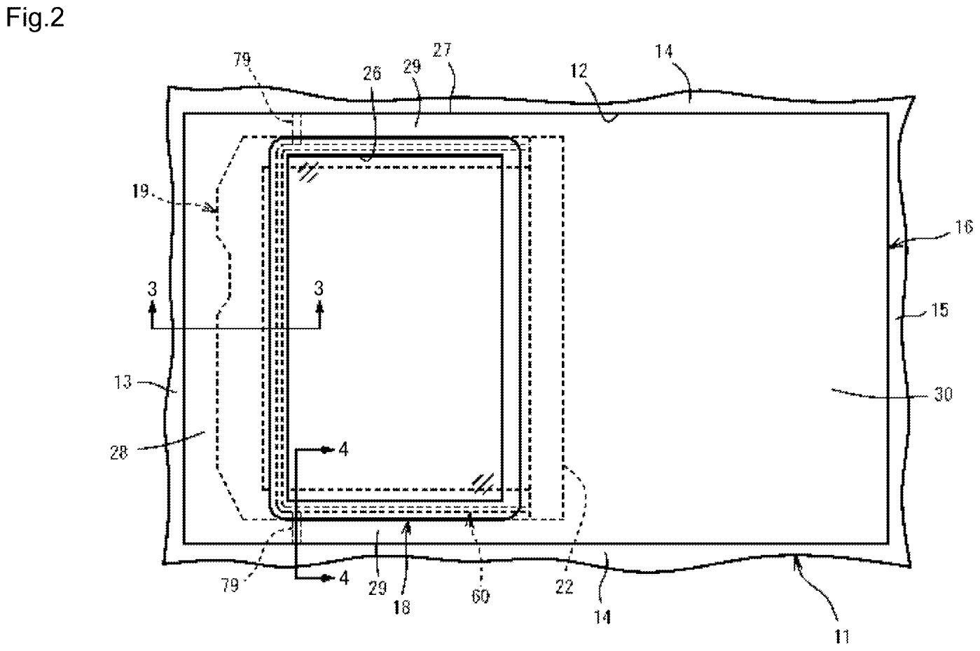

As shown in FIGS. 1 and 2, the vehicle roof device of the present embodiment is provided to cover a body opening 12, which is formed in a roof of a vehicle body 11. The body opening 12 is rectangular and continuous with the passenger compartment. The body 11 includes a front body portion 13 located forward of the body opening 12. The body 11 includes side body portions 14 on the left and right sides of the body opening 12, and a rear body portion 15 located rearward of the body opening 12. A windshield (not shown) is located forward of the front body portion 13, and a rear window (not shown) is located rearward of the rear body portion 15.

The vehicle roof device includes a plastic roof panel 16, which is substantially rectangular and includes an opening 17, a roof window 18, which is capable of closing the opening 17, and an actuating mechanism 19, which opens or closes the roof window 18. The details of the plastic roof panel 16 will be discussed below.

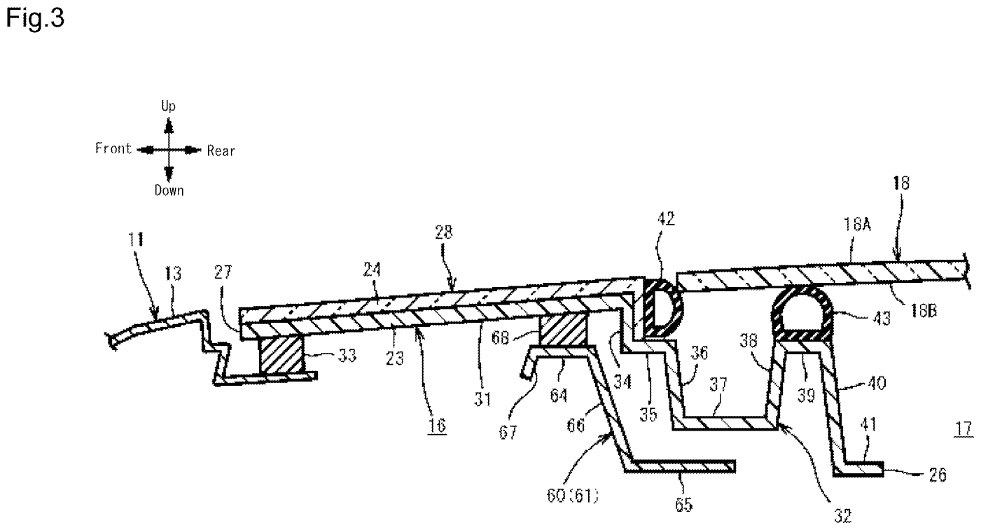

The roof window 18 is a sheet of colorless transparent inorganic glass having a uniform thickness. The roof window 18 is formed to have a rectangular shape such that its dimension in the front-rear direction is less than its dimension in the left-right direction. As shown in FIG. 3, the roof window 18 includes an outer face 18A, which faces the outside of the vehicle, and a back face 18B, which faces the passenger compartment below.

As shown in FIG. 1, the actuating mechanism 19 includes two rails 20 and two sliding members 21. The rails 20 are arranged to extend parallel with each other in the front-rear direction, and are coupled to each other by a center reinforcement 22. The sliding members 21 are fixed to the back face 18B of the roof window 18. The actuating mechanism 19 includes a driving motor (not shown), which causes the sliding members 21 to slide. When the driving motor is activated to move the sliding members 21 rearward relative to the rails 20, the roof window 18, which is in a state of closing the opening 17, moves rearward over the upper side of the plastic roof panel 16, which opens the opening 17. The actuating mechanism 19 has the same construction as that of a known actuating mechanism.

The plastic roof panel 16 is formed to have a rectangular shape such that its dimension in the front-rear direction is greater than its dimension in the left-right direction. The plastic roof panel 16 is formed by two-color molding, and includes a panel main section 23 and a surface layer 24, which is formed on the surface of the panel main section 23 (refer to FIG. 3). The panel main section 23 is made of a blackened opaque plastic. The plastic roof panel 16 is larger than the actuating mechanism 19 so as to cover the actuating mechanism 19 from above.

The plastic roof panel 16 includes an opening 17, which can be continuous with the passenger compartment. The opening 17 is provided in a front portion of the plastic roof panel 16. The plastic roof panel 16 includes an inner peripheral edge 26, which forms the opening 17, and a substantially rectangular outer peripheral edge 27. A deflector (not shown) is attached to the front end of the plastic roof panel 16. The deflector can be moved vertically. The deflector suppresses the generation of wind roar when the roof window 18 is open.

As shown in FIGS. 1 and 2, the plastic roof panel 16 includes a front panel section 28, which is located forward of the opening 17, and two side panel sections 29, which extend rearward from the left and right ends of the front panel section 28 and are located on the left and right sides of the opening 17. The plastic roof panel 16 further includes a rear panel section 30, which is located rearward of the opening 17.

The front panel section 28 extends in the left-right direction along the inner peripheral edge 26. As shown in FIG. 3, the front panel section 28 includes a front panel base 31, which is fixed to the body 11, and a front panel extension 32, which extends from the front panel base 31 toward the opening 17. The front panel base 31 is a substantially flat portion. The driving motor (not shown) of the actuating mechanism 19 is located below the front panel base 31. The front panel base 31 is bonded to the body 11 with a bonding portion 33 in the vicinity of the edge closest to the body 11. The bonding portion 33 is made of a urethane resin adhesive.

As shown in FIG. 3, the front panel extension 32 includes a first wall 34, a first horizontal portion 35, a second wall 36, a bottom wall 37, a third wall 38, a second horizontal portion 39, a fourth wall 40, and an inner edge 41. The first wall 34 extends downward from the inner (rear) edge of the front panel base 31. A first weather strip 42, which contacts the front edge of the roof window 18, is attached to the first wall 34. The first weather strip 42 prevents entry of water or noise into the passenger compartment through the clearances between the front panel base 31 and the roof window 18.

The first horizontal portion 35 extends in a horizontal direction from the lower end of the first wall 34 toward the opening 17. The second wall 36 extends downward from the inner (rear) edge of the first horizontal portion 35. The bottom wall 37 extends in a horizontal direction from the lower end of the second wall 36 toward the opening 17. The third wall 38 extends upward from the inner (rear) edge of the bottom wall 37.

The second horizontal portion 39 extends in a horizontal direction from the upper end of the third wall 38 toward the opening 17. A second weather strip 43, which contacts the back face 18B of the roof window 18, is attached to the upper surface of the second horizontal portion 39. The second weather strip 43 prevents entry of water or noise into the opening 17, which is located rearward of the second horizontal portion 39.

The fourth wall 40 extends toward the opening 17 from the inner (rear) edge of the second horizontal portion 39. The inner edge 41 extends in a horizontal direction from the lower end of the fourth wall 40 toward the opening 17. The inner edge 41 is located at a position downward of the bottom wall 37. The second wall 36, the bottom wall 37, and the third wall 38 form a groove extending in the left-right direction.

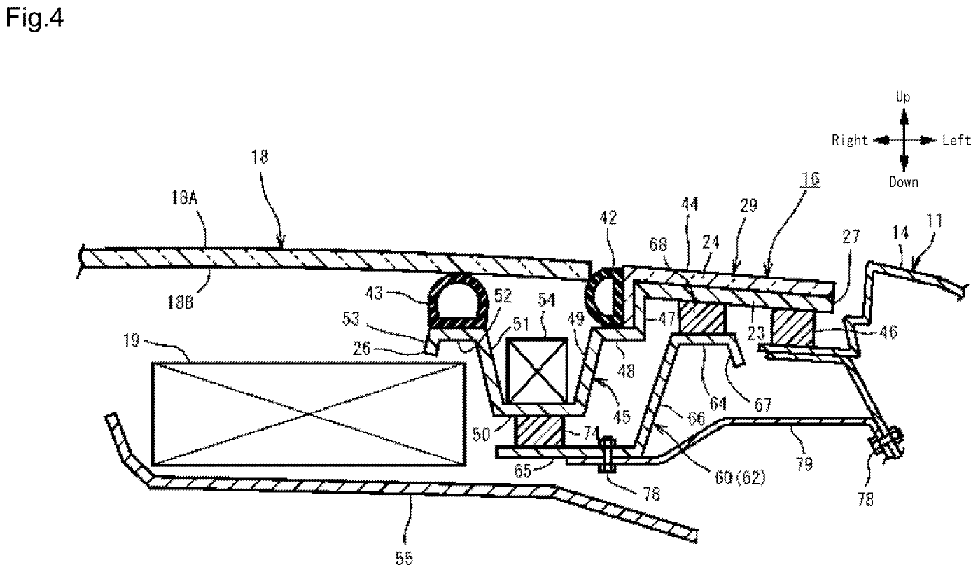

The side panel sections 29 will now be described. Each side panel section 29 extends in the front-rear direction along the inner peripheral edge 26. As shown in FIG. 4, each side panel section 29 includes a side panel base 44, which is fixed to the body 11, and a side panel extension 45, which extends from the side panel base 44 toward the opening 17. The side panel base 44 is a substantially flat portion. The side panel base 44 is bonded to the body 11 with a bonding portion 46 in the vicinity of the edge closest to the body 11. The bonding portion 46 is made of a urethane resin adhesive. The dimension in the left-right direction, which is the width, of the side panel base 44 is less than the dimension in the front-rear direction, which is the width, of the front panel base 31.

As shown in FIG. 4, the side panel extension 45 includes a first wall 47, a first horizontal portion 48, a second wall 49, a bottom wall 50, a third wall 51, a second horizontal portion 52, and a fourth wall 53. The first wall 47 extends downward from the inner edge of the side panel base 44. The first weather strip 42, which contacts a side edge of the roof window 18, is attached to the first wall 47. The first weather strip 42 prevents entry of water or noise through the clearances between the side panel base 44 and the roof window 18. The first weather strip 42 is loop-shaped to surround the opening 17, and is located on the plastic roof panel 16.

As shown in FIG. 4, the first horizontal portion 48 extends in a horizontal direction from the lower end of the first wall 47 toward the opening 17. The second wall 49 extends downward from the inner edge of the first horizontal portion 48. The bottom wall 50 extends in a horizontal direction from the lower end of the second wall 49 toward the opening 17. The third wall 51 extends upward from the inner edge of the bottom wall 50.

The second horizontal portion 52 extends in a horizontal direction from the upper end of the third wall 51 toward the opening 17. The second weather strip 43, which contacts the back face 18B of the roof window 18, is attached to the upper surface of the second horizontal portion 52. The second weather strip 43 prevents entry of water or noise into the opening 17, which is located inward of the second horizontal portion 52. The second weather strip 43 is loop-shaped to surround the opening 17.

The fourth wall 53 extends toward the opening 17 from the inner edge of the second horizontal portion 52. The second wall 49, the bottom wall 50, and the third wall 51 form a groove extending in the front-rear direction. As shown in FIG. 4, an arm member 54 of the deflector is located inside the groove. An interior panel 55, which faces the passenger compartment, is provided below the side panel section 29. The interior panel 55 is fixed to the body 11 and overhangs toward the opening 17. Part of the actuating mechanism 19 (such as the rails 20, and the sliding members 21) is located between the interior panel 55 and the roof window 18.

The vehicle roof device of the present embodiment includes a frame member 60, which is bonded to the back face of the plastic roof panel 16 so as to extend along the inner peripheral edge 26. As shown in FIG. 2, the frame member 60 is substantially U-shaped in a plan view, so as to extend along the front panel extension 32 and the left and right side panel extensions 45. The frame member 60 is provided to increase the stiffness of the plastic roof panel 16, thereby reducing deformation of the plastic roof panel 16 due to thermal contraction.

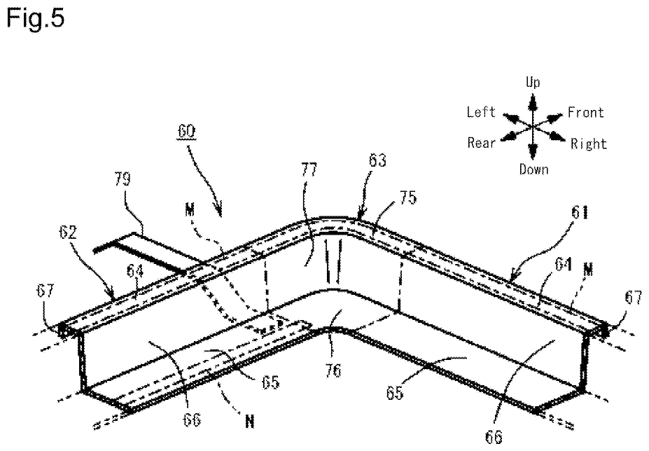

As shown in FIG. 5, the frame member 60 includes a front frame section 61, which extends along the front panel section 28, two side frame sections 62 (only one is shown), which extend along the side panel sections 29, and corner frame sections 63, which are located at corners between the front frame section 61 and the side frame sections 62. The front frame section 61, the two side frame sections 62, and the two corner frame sections 63 are formed integrally. As shown in FIG. 2, the rear ends of the side frame sections 62 are fastened with bolts or welded to the center reinforcement 22.

The front frame section 61 includes an upper wall 64, which is opposed to the front panel base 31, a bottom wall 65, which is opposed to the bottom wall 37 of the front panel extension 32, an inner wall 66, which connects the upper wall 64 and the bottom wall 65 to each other, and an outer wall 67, which extends downward from an end of the upper wall 64 that is closest to the body 11. The front frame section 61 is formed by bending a metal plate and has a shape that readily resists bending stress. As shown in FIG. 3, the upper wall 64 is bonded to the back face of the front panel base 31 with a bonding portion 68. The bonding portion 68 is made of a urethane resin adhesive. In FIG. 5, the bonding portion 68 is indicated by the long-dash double-short-dash line M. When the front frame section 61 is bonded to the front panel base 31, the upper wall 64 and the bottom wall 65 are substantially horizontal. In the present embodiment, the bottom wall 65 of the front frame section 61 is not bonded to the front panel extension 32.

The side frame sections 62 will now be described. Each side frame section 62 includes an upper wall 64, which is opposed to the side panel base 44, a bottom wall 65, which is opposed to the bottom wall 50 of the side panel extension 45, an inner wall 66, which connects the upper wall 64 and the bottom wall 65 to each other, and an outer wall 67, which extends downward from an end of the upper wall 64 that is closest to the body 11. Each side frame section 62 is formed by bending a metal plate and has a shape that readily resists bending stress like the front frame section 61. As shown in FIG. 4, the upper wall 64 is bonded to the back face of the side panel base 44 with a bonding portion 68. Also, the bottom wall 65 is bonded to the back face of the bottom wall 50 of the corresponding side panel extension 45 with a bonding portion 74. The bonding portion 74 is made of a urethane resin adhesive. In FIG. 5, the bonding portion 74 is indicated by the long-dash double-short-dash line N. When each side frame section 62 is bonded to the corresponding side panel base 44 and the corresponding side panel extension 45, the upper wall 64 and the bottom wall 65 are substantially horizontal.

As shown in FIG. 5, each corner frame section 63 connects the front frame section 61 and the corresponding side frame section 62, and includes an upper wall 75, a bottom wall 76, an inner wall 77, and an outer wall (not shown). The upper wall 75 connects the upper wall 64 of the front frame section 61 and the upper wall 64 of the corresponding side frame section 62 to each other. The bottom wall 76 connects the bottom wall 65 of the front frame section 61 and the bottom wall 65 of the corresponding side frame section 62 to each other. The inner wall 77 connects the inner wall 66 of the front frame section 61 and the inner wall 66 of the corresponding side frame section 62 to each other. The outer wall of the corner frame section 63 connects the outer wall 67 of the front frame section 61 and the outer wall 67 of the corresponding side frame section 62 to each other. The bonding portion 68 extends continuously along the upper wall 64 of the front frame section 61, the upper walls 75 of the corner frame sections 63, and the upper walls 64 of the side frame sections 62.

As shown in FIGS. 2, 4, and 5, the frame member 60 is fixed to the body 11 with two brackets 79 in the present embodiment. Specifically, each side frame section 62 is connected to the corresponding side body portion 14 with one of the brackets 79. The opposite ends of each bracket 79 are, for example, fastened with a bolt 78 or welded to the frame member 60 and the body 11, respectively. Each bracket 79 connects the front end of the corresponding side frame section 62 to the corresponding side frame section 62.

An operation of the vehicle roof device of the present embodiment will now be described. If the actuating mechanism 19 is activated when the roof window 18 is covering the opening 17, the roof window 18 slides rearward over the plastic roof panel 16 to open the opening 17. If the actuating mechanism 19 is activated when the roof window 18 is not covering the opening 17, the roof window 18 slides forward over the plastic roof panel 16 to cover the opening 17.

The plastic roof panel 16 of the vehicle roof device is made of a plastic and is thus easily deformed due to thermal contraction. However, the frame member 60, which is bonded to the back face of the plastic roof panel 16, limits deformation of the plastic roof panel 16 due to thermal contraction. Each side frame section 62 of the frame member 60 is bonded to the corresponding side panel section 29 at two locations. Specifically, each side frame section 62 is bonded to the side panel base 44 and to the side panel extension 45. The side frame section 62 limits deformation of the side panel section 29 due to thermal contraction by retaining the side panel section 29 at two locations.

The front frame section 61 of the frame member 60 is bonded to the front panel section 28 at one location. That is, the front frame section 61 is bonded to the front panel base 31, but is not bonded to the front panel extension 32. In the present embodiment, the distance from the inner peripheral edge 26 to the outer peripheral edge 27 of the front panel section 28 is sufficiently greater than the distance from the inner peripheral edge 26 to the outer peripheral edge 27 of each side panel section 29 such that, if the front frame section 61 retains the front panel section 28 at two locations, deformation of the plastic roof panel 16 due to thermal contraction may warp the front panel section 28 between the retained two locations, so that the front panel extension 32 may be largely displaced upward. To prevent such warping of the front panel section 28, the present embodiment bonds the front frame section 61 to one location on the front panel base 31. This prevents a local excessive deformation of the front panel section 28 due to thermal contraction.

In the present embodiment, although the front panel section 28 is retained by the frame member 60 at one location, each side panel section 29 is retained by the frame member 60 at two locations. This enhances the overall stiffness of the plastic roof panel 16, and deformation of the plastic roof panel 16 due to thermal contraction is properly restricted and limited by the frame member 60.

The vehicle roof device of the present embodiment has the following advantages.

(1) Since the frame member 60, which is fixed to the body 11, is bonded to the back face of the plastic roof panel 16, the frame member 60 increases the stiffness of the plastic roof panel 16. The frame member 60 thus further limits deformation of the plastic roof panel 16 due to thermal contraction.

(2) Since the frame member 60 is bonded to the back faces of the front panel section 28 and each side panel section 29, the stiffness of the front panel section 28 and the side panel sections 29 is increased. This limits deformation of the front panel section 28 and the side panel sections 29 due to thermal contraction. Also, the rear ends of the side frame sections 62 are coupled to the center reinforcement 22. This enhances the stiffness of the frame member 60.

(3) The frame member 60 is bonded to the back faces of the front panel base 31, the side panel bases 44, and the side panel extensions 45, without being bonded to the front panel extension 32. Since the frame member 60 is not bonded to the front panel extension 32, local deformation of the front panel section 28 due to thermal contraction is limited.

### Second Embodiment

A vehicle roof device according to a second embodiment will now be described. The vehicle roof device of the present embodiment has a frame member of a structure different than that of the first embodiment. In the present embodiment, the explanations of the first embodiment are applied to those components that are the same as the corresponding components of the first embodiment, and the same reference numerals are employed.

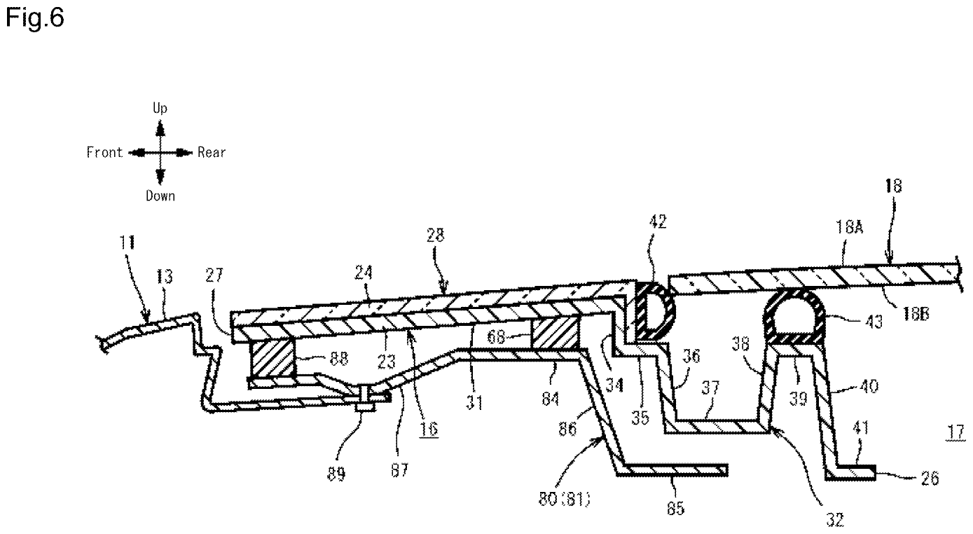

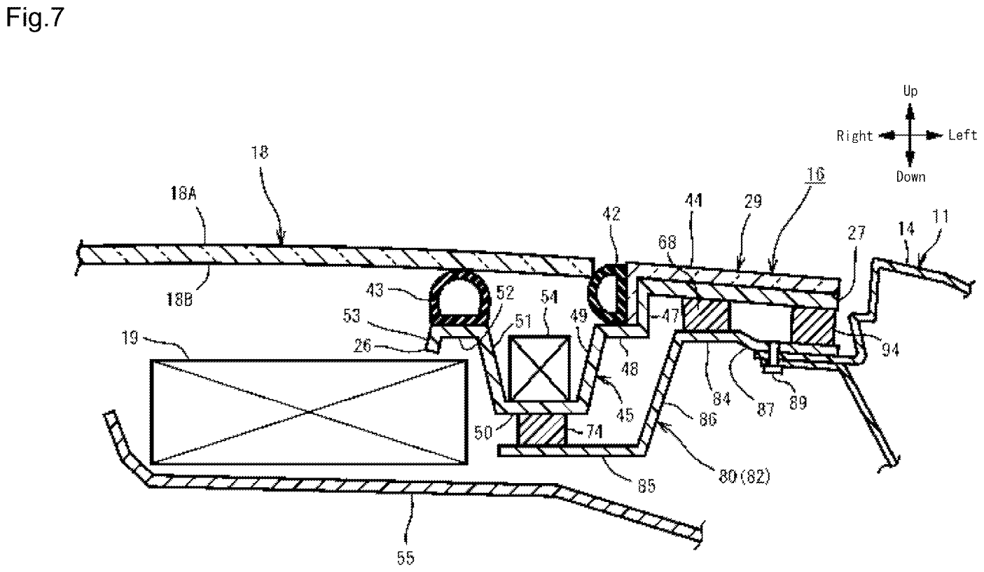

A frame member 80 includes a front frame section 81 and two side frame sections 82 (only one is shown) as shown in FIGS. 6 and 7. The frame member 80 also includes corner frame sections (not shown) each located between the front frame section 81 and the corresponding side frame section 82. As shown in FIG. 6, the front frame section 81 includes an upper wall 84, which is opposed to the front panel base 31, a bottom wall 85, which is opposed to the bottom wall 37 of the front panel extension 32, an inner wall 86, which connects the upper wall 84 and the bottom wall 85 to each other, and an extension 87, which extends toward the body 11 from an end of the upper wall 84 that is closest to the body 11. The upper wall 84 is bonded to the back face of the front panel base 31 with a bonding portion 68. The bonding portion 68 is made of a urethane resin adhesive. In the present embodiment, the bottom wall 85 of the front frame section 61 is not bonded to the front panel extension 32.

A portion of the extension 87 close to the outer edge is bonded to the back face of the front panel section 28 with a bonding portion 88. A portion of the front body portion 13 extends to be located below the extension 87. The extension 87 is fastened to the front body portion 13 with a bolt 89. That is, the front panel section 28 is fixed to the body 11 with the front frame section 81 in between.

As shown in FIG. 7, each side frame section 82 includes an upper wall 84, which is opposed to the corresponding side panel base 44, a bottom wall 85, which is opposed to the bottom wall 50 of the corresponding side panel extension 45, an inner wall 86, which connects the upper wall 84 and the bottom wall 85 to each other, and an extension 87, which extends toward the body 11 from an end of the upper wall 84 that is closest to the body 11. The upper wall 84 is bonded to the back face of the side panel base 44 with a bonding portion 68. Also, the bottom wall 85 is bonded to the back face of the bottom wall 50 of the side panel extension 45 with a bonding portion 74.

A portion of the extension 87 close to the outer edge is bonded to the back face of the corresponding side panel section 29 with a bonding portion 94. A portion of the corresponding side body portion 14 extends to be located below the extension 87. The extension 87 is fastened to the side body portion 14 with a bolt 89. That is, each side panel section 29 is fixed to the body 11 with the corresponding side frame section 82 in between. The side frame section 82 is thus not provided with the brackets 79. As described above, the plastic roof panel 16 of the present embodiment is fixed to the body 11 with the frame member 80 in between. The plastic roof panel 16 is bonded to the frame member 80 without being bonded to the body 11. In this regard, the present embodiment is different from the first embodiment, in which the plastic roof panel 16 is bonded to both the body 11 and the frame member 60. The extension 87 corresponds to a bolt-fastened portion that is fastened to the body 11 with the bolt 89.

The present embodiment has advantages similar to the advantages (1) to (3) of the first embodiment. Also, since the frame member 80 is fixed to the body 11 with the bolts 89, the vehicle roof device can be removed from the body 11 by unscrewing the bolts 89 to remove the body 11 from the frame member 80. As compared to a case in which the plastic roof panel 16 is bonded to the body 11, the vehicle roof device is easily attached to and detached from the body 11.

First Modification

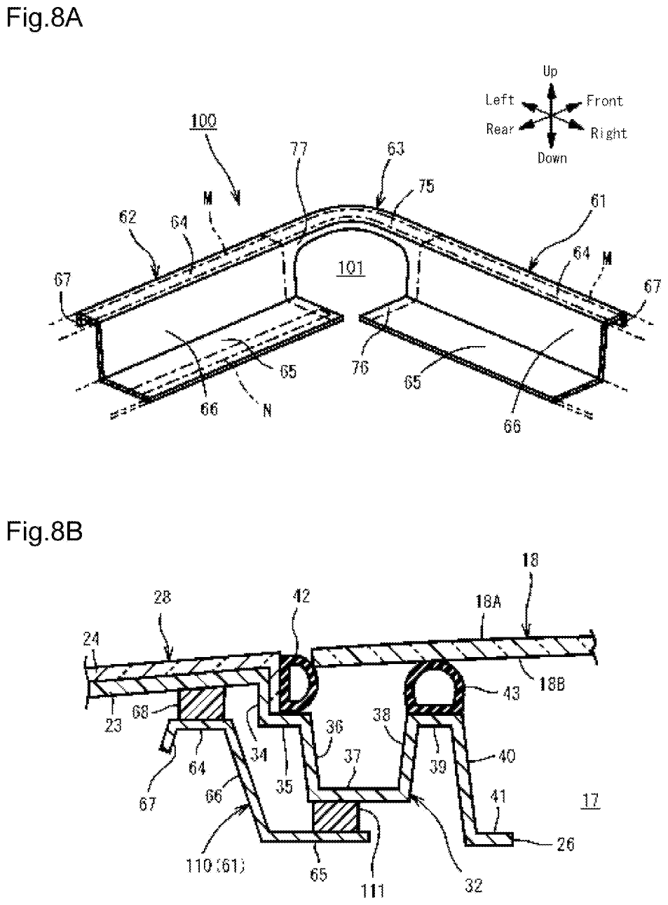

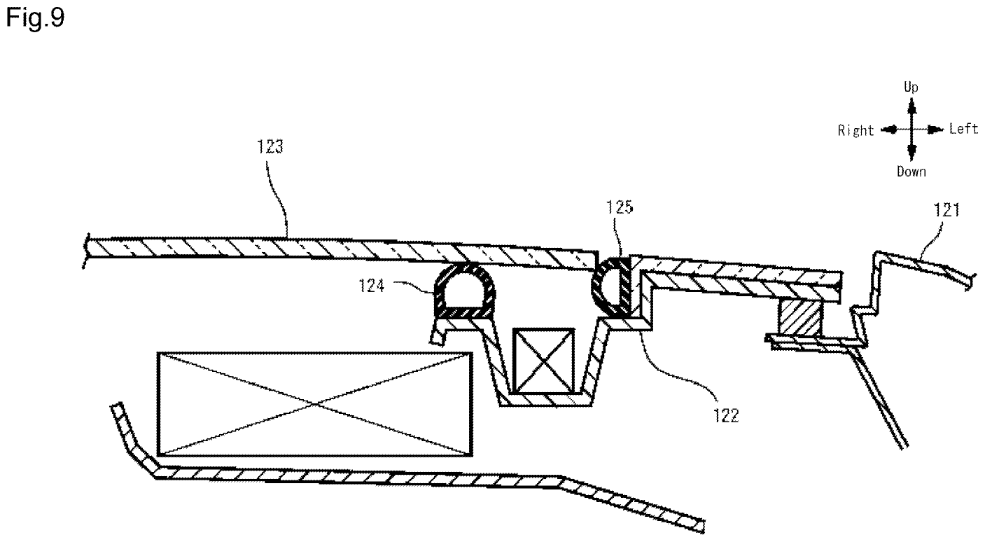

A frame member according to a first modification will now be described. As shown in FIG. 8A, a frame member 100 of the first modification includes a cutout 101 at each position corresponding to one of the corner frame sections 63. The cutout 101 is formed by removing most of the inner wall 77 and the bottom wall 76 at the section corresponding to the corner frame section 63. The first modification readily limits deformation of the plastic roof panel 16 due to thermal contraction. In addition, the first modification readily provides space for a component (not shown) for installing the vehicle roof device and/or a component (not shown) for drainage. The size and/or shape of the cutouts 101 are determined in accordance with various conditions such as the size and/or shape of the plastic roof panel 16 and/or the frame member 100. In FIG. 8A, the brackets 79 are omitted.

Second Modification

A frame member according to a first modification will now be described. As shown in FIG. 8B, a frame member 110 of the second modification includes a bottom wall 65 of a front frame section 61. The bottom wall 65 is bonded to the back face of the front panel extension 32 with a bonding portion 111. In the second modification, the distance from the inner peripheral edge 26 to the outer peripheral edge 27 of the front panel section 28 is sufficiently the same as the distance from the inner peripheral edge 26 to the outer peripheral edge 27 of each side panel section 29. Thus, even if the bottom wall 65 of the front frame section 61 is bonded to the back face of the front panel extension 32 with the bonding portion 111, deformation of the front frame section 61 due to thermal contraction does not warp the front panel section 28. Therefore, the frame member 110 is bonded at two locations on the front panel section 28, so that the front panel section 28 is retained.

The first and second embodiments and the first and second modifications can be combined as long as the combined modifications remain technically consistent with each other, and the embodiments and the modifications may be modified in the following manner.

The frame member does not necessarily need to be substantially U-shaped in a plan view, but may have the shape of a substantially rectangular frame that extends around the entire periphery of the opening 17. The frame member does not necessarily need to be a single member, but may be a combination of separate members. The frame member may also be formed to extend along only part of the inner peripheral edge of the opening 17.

The roof window 18 does not necessarily need to be made of a sheet of inorganic glass, but may be made of plastic. In this case, the weight of the vehicle roof device is reduced.

1. A vehicle roof device, comprising:
a plastic roof panel that is configured to be fixed to a body of a vehicle and includes an inner peripheral edge forming a substantially rectangular opening;
a roof window that is capable of closing the opening; and
a frame member that is bonded to a back face of the plastic roof panel so as to extend along the inner peripheral edge,
wherein the frame member is fixed to the body.

2. The vehicle roof device according to claim 1, wherein
the plastic roof panel includes
a front panel section located forward of the opening, and
two side panel sections that respectively extend rearward from left and right ends of the front panel section, the side panel sections being respectively located on left and right sides of the opening, and
the frame member is bonded to back faces of the front panel section and the side panel sections.

3. The vehicle roof device according to claim 2, wherein
the front panel section includes:
a front panel base that is configured to be fixed to the body, and
a front panel extension that extends from the front panel base toward the opening, each side panel section includes:
a side panel base that is configured to be fixed to the body, and
a side panel extension that extends from the side panel base toward the opening, and
the frame member is bonded to back faces of the front panel base, the side panel bases, and the side panel extensions, without being bonded to a back face of the front panel extension.

4. The vehicle roof device according to claim 2, wherein the frame member includes cutouts, each located at a position corresponding to a corner of the opening.

5. The vehicle roof device according to claim 1, wherein the frame member includes a bolt-fastened portion configured to be fastened to the body with a bolt.

6. The vehicle roof device according to claim 5, wherein the plastic roof panel is configured to be fixed to the body with the frame member in between.

7. The vehicle roof device according to claim 5 or 6, wherein the plastic roof panel is not bonded to the body.
